(19) United States
(12) Patent Application Publication
(10) Pub. No.: US 2019/0089185 A1
(43) Pub. Date: Mar. 21, 2019

(54) Wireless Charging System With Radio-Frequency Antennas

(71) Applicant: Apple Inc., Cupertino, CA (US)

(72) Inventors: Lu Zhang, Shanghai (CN); Jiangfeng Wu, San Jose, CA (US); Yi Jiang, Cupertino, CA (US); Siwen Yong, San Francisco, CA (US); Lijun Zhang, San Jose, CA (US)

(21) Appl. No.: 15/707,932

(22) Filed: Sep. 18, 2017

(51) Int. Cl. H02J 7/02; H01Q 13/10; H02J 50/23; H02J 50/27

(52) U.S. Cl. CPC H02J 7/025; H02J 50/27; H02J 50/23; H01Q 13/10

(57) ABSTRACT

A wireless power transmission system has a wireless power receiving device that is configured to receive power from a wireless power transmitting device. The power transmitting device may have a conductive housing portion at a front face and a reflector at a rear face that form a cavity for an antenna that is configured to transmit wireless charging signals to the power receiving device. The power transmitting device may be a desktop computer. The power receiving device may include an antenna that receives signals from the power transmitting device and rectifier circuitry that converts signals from the antenna to corresponding rectified direct current voltage signals that may be used to charge a battery in the power receiving device. The antenna may include a cavity formed from a conductive housing for the power receiving device. The power receiving device may be an accessory such as a keyboard, trackpad, or computer mouse.

### BACKGROUND

This relates generally to electronic devices and, more particularly, to electronic devices with wireless communications circuitry.

Electronic devices often include wireless communications circuitry. For example, cellular telephones, computers, and other devices often contain antennas and wireless transceivers for supporting wireless communications. Electronic devices may have corresponding electronic device accessories.

It can be challenging to form electronic devices and electronic device accessories with desired attributes. In some devices, antennas are bulky. In other devices, antennas are compact, but are sensitive to the position of the antennas relative to external objects. If care is not taken, antennas may become detuned or may otherwise not perform as expected.

Some electronic device accessories have batteries. However, the batteries may need to be recharged frequently.

It would therefore be desirable to be able to provide improved wireless circuitry for electronic devices and electronic device accessories.

### SUMMARY

A wireless power transmission system has a wireless power receiving device that is configured to receive power from a wireless power transmitting device.

The wireless power transmitting device may include an antenna that is configured to transmit wireless charging signals to the wireless power receiving device. The wireless power transmitting device may have a conductive housing portion at a front face and a reflector at a rear face that form a cavity for the antenna. The antenna may be a slot antenna formed by a slot in the conductive housing portion or a patch antenna formed in an opening in the conductive housing portion. The wireless power transmitting device may be a desktop computer. The desktop computer may include a display with a transparent cover layer that rests on an upper edge of the conductive housing portion.

The wireless power receiving device may include an antenna that receives the wireless charging signals from the wireless power transmitting device. The wireless power receiving device may include rectifier circuitry that converts signals from the antenna to a corresponding rectified direct current voltage that may be used to charge a battery in the wireless power receiving device. The antenna may be a slot antenna or inverted-F antenna with portions formed from a conductive housing for the wireless power receiving device. The wireless power receiving device may be a keyboard, a trackpad, or a computer mouse.

The wireless charging signals may be transmitted from the wireless power transmitting device to the wireless power receiving device at a frequency between 500 MHz and 6000 MHz (e.g., 900 MHz) or another desired frequency.

### BRIEF DESCRIPTION OF THE DRAWINGS

FIG. 1 is a schematic diagram of an illustrative wireless charging system that includes a wireless power transmitting device and a wireless power receiving device in accordance with an embodiment.

FIG. 2 is a schematic diagram of an illustrative wireless charging system including a wireless power transmitting device with an antenna and a wireless power receiving device with an antenna in accordance with an embodiment.

FIG. 3 is a perspective view of an illustrative wireless charging system with a desktop computer and a keyboard in accordance with an embodiment.

FIG. 4 is a perspective view of an illustrative wireless charging system with a desktop computer and a trackpad in accordance with an embodiment.

FIG. 5 is a perspective view of an illustrative wireless charging system with a desktop computer and a computer mouse in accordance with an embodiment.

FIG. 6A is a diagram of illustrative wireless circuitry in a wireless power transmitting device in accordance with an embodiment.

FIG. 6B is a diagram of illustrative wireless circuitry in a wireless power receiving device in accordance with an embodiment.

FIG. 7 is a schematic diagram of an illustrative inverted-F antenna in accordance with an embodiment.

FIG. 8 is a schematic diagram of an illustrative slot antenna in accordance with an embodiment.

FIG. 9 is a schematic diagram of an illustrative patch antenna in accordance with an embodiment.

FIG. 10 is a perspective view of an illustrative wireless power transmitting device with a slot antenna in accordance with an embodiment.

FIG. 11 is a perspective view of an illustrative wireless power transmitting device with a patch antenna in accordance with an embodiment.

FIG. 12 is a perspective view of an illustrative wireless power transmitting device with multiple antennas for transmitting wireless power signals in accordance with an embodiment.

FIG. 13 is a side view of an illustrative wireless power transmitting device configured to direct wireless power signals towards a wireless power receiving device in accordance with an embodiment.

FIG. 14 is a perspective view of an illustrative wireless power receiving device with an inverted-F antenna on an edge surface in accordance with an embodiment.

FIG. 15 is a perspective view of an illustrative wireless power receiving device with a slot antenna in accordance with an embodiment.

FIG. 16 is a perspective view of an illustrative wireless power receiving device with a patch antenna in accordance with an embodiment.

FIG. 17 is a perspective view of an illustrative wireless power receiving device with an inverted-F antenna on a bottom surface in accordance with an embodiment.

### DETAILED DESCRIPTION

A wireless power system may have a wireless power transmitting device such as desktop computer. The wireless power transmitting device may wirelessly transmit power to a wireless power receiving device such as a keyboard, trackpad, mouse, wristwatch, cellular telephone, tablet computer, laptop computer, or other electronic device. The wireless power receiving device may use power from the wireless power transmitting device for powering the device and for charging an internal battery.

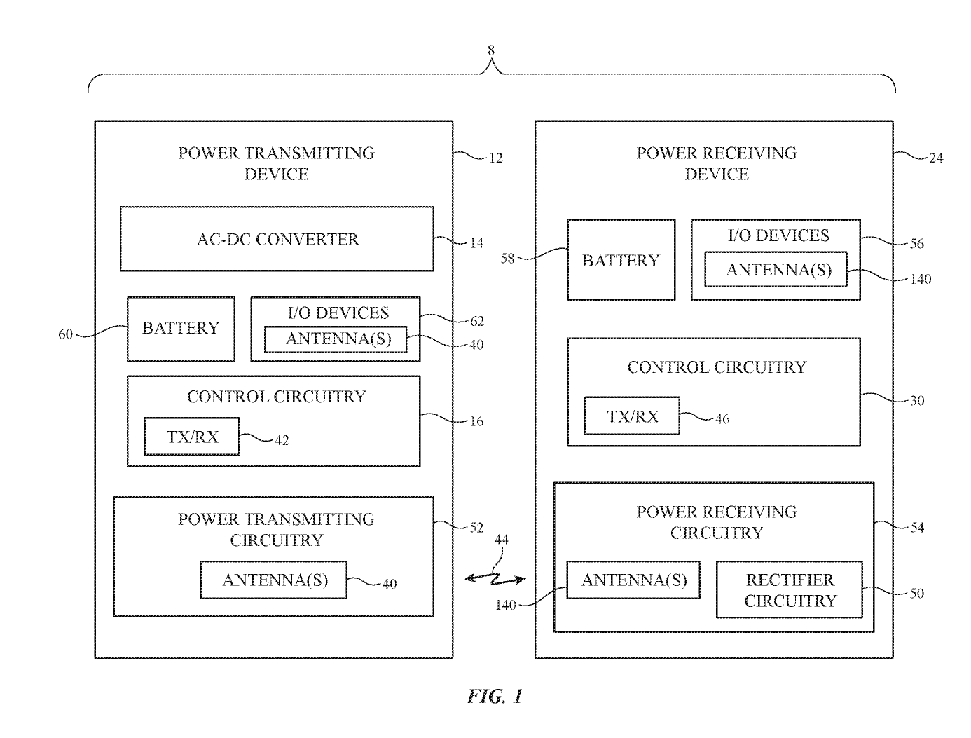

An illustrative wireless power system (wireless charging system) is shown in FIG. 1. As shown in FIG. 1, wireless power system 8 may include a wireless power transmitting device such as wireless power transmitting device 12 and may include a wireless power receiving device such as wireless power receiving device 24. Wireless power transmitting device 12 may include control circuitry 16. Wireless power receiving device 24 may include control circuitry 30. Control circuitry in system 8 such as control circuitry 16 and control circuitry 30 may be used in controlling the operation of system 8. This control circuitry may include processing circuitry associated with microprocessors, power management units, baseband processors, digital signal processors, microcontrollers, and/or application-specific integrated circuits with processing circuits. This processing circuitry implements desired control and communications features in devices 12 and 24. For example, the processing circuitry may be used in determining power transmission levels, processing sensor data, processing user input, handling negotiations between devices 12 and 24, sending and receiving in-band and out-of-band data packets, and processing other information and using this information to adjust the operation of system 8.

Control circuitry in system 8 may be configured to perform operations in system 8 using hardware (e.g., dedicated hardware or circuitry), firmware and/or software. Software code for performing operations in system 8 is stored on non-transitory computer readable storage media (e.g., tangible computer readable storage media) in control circuitry 8. The software code may sometimes be referred to as software, data, program instructions, instructions, or code. The non-transitory computer readable storage media may include non-volatile memory such as non-volatile random-access memory (NVRAM), one or more hard drives (e.g., magnetic drives or solid state drives), one or more removable flash drives or other removable media, or the like. Software stored on the non-transitory computer readable storage media may be executed on the processing circuitry of control circuitry 16 and/or 30. The processing circuitry may include application-specific integrated circuits with processing circuitry, one or more microprocessors, a central processing unit (CPU) or other processing circuitry.

Power transmitting device 12 may be a desktop computer, a laptop computer, a tablet computer, a set-top box, a display into which a computer or other processing circuitry has been integrated, a display without an integrated computer, a handheld device such as a cellular telephone, a speaker, or other suitable electronic equipment. Power transmitting device 12 may be a stand-alone power adapter (e.g., a wireless charging device that includes power adapter circuitry), may be a wireless charging device that is coupled to a power adapter or other equipment by a cable, may be a portable device, may be equipment that has been incorporated into furniture, a vehicle, or other system, or may be other wireless power transfer equipment. Illustrative configurations in which wireless power transmitting device 12 is a desktop computer may sometimes be described herein as an example.

Power receiving device 24 may be a laptop computer, a tablet computer, a somewhat smaller device such as a wrist-watch device, pendant device, headphone device, a speaker earpiece device, headset device (e.g., virtual or augmented reality headset device), or other wearable or miniature device, a handheld device such as a cellular telephone, a media player, or other small portable device. Power receiving device 24 may also be a speaker, a set-top box, a camera device with wireless communications capabilities, a desktop computer, a display into which a computer or other processing circuitry has been integrated, a display without an integrated computer, or other suitable electronic equipment. In some cases, power receiving device 24 may be an electronic device accessory (e.g., a keyboard, trackpad, mouse, speaker, stylus, etc.). Power receiving device 24 may be electronic equipment such as a thermostat, a smoke detector, a Bluetooth® Low Energy (Bluetooth LE) beacon, a WiFi® wireless access point, a wireless base station, a server, a heating, ventilation, and air conditioning (HVAC) system (sometimes referred to as a temperature-control system), a light source such as a light-emitting diode (LED) bulb, a light switch, a power outlet, an occupancy detector (e.g., an active or passive infrared light detector, a microwave detector, etc.), a door sensor, a moisture sensor, an electronic door lock, a security camera, or other device.

Power transmitting device 12 may be coupled to a wall outlet (e.g., alternating current), may have a battery for supplying power, and/or may have another source of power. Power transmitting device 12 may have an AC-DC power converter such as power converter 14 for converting AC power from a wall outlet or other power source into DC power. DC power may be used to power control circuitry 16, power a battery such as battery 60, and/or power other components in device 12. For example, device 12 may include input-output devices 62. Input-output devices 62 may include user interface devices, data port devices, and other input-output components. For example, input-output devices 62 may include touch screens, displays without touch sensor capabilities, buttons, joysticks, scrolling wheels, touch pads, key pads, keyboards, microphones, cameras, buttons, speakers, status indicators, light sources, audio jacks and other audio port components, digital data port devices, light sensors, position and orientation sensors (e.g., sensors such as accelerometers, gyroscopes, and compasses), capacitance sensors, proximity sensors (e.g., capacitive proximity sensors, light-based proximity sensors, etc.), and/or fingerprint sensors. Input-output devices 62 may be powered by the DC voltages produced by power converter 14 (and/or DC voltages produced by battery 60).

During operation, a controller in control circuitry 16 may use power transmitting circuitry 52 to transmit wireless power to power receiving circuitry 54 of device 24. Power transmitting circuitry 52 may transfer radio-frequency signals 44 using one or more antennas 40. Corresponding antenna(s) 140 in power receiving circuitry 54 of wireless power receiving device 24 may receive the radio-frequency signals 44 and harvest wireless power from the radio-frequency signals using rectifier circuitry 50. Radio-frequency signals 44 may be conveyed at any desired frequency (e.g., 900 MHz, between 880 and 920 MHz, between 850 and 950 MHz, between 800 and 1000 MHz, between 800 MHz and 2000 MHz, greater than 500 MHz, less than 400 MHz, 2400 MHz, between 2400 and 2500 MHz, 5 GHz, between 5000 MHz and 6000 MHz, between 500 MHz and 6000 MHz, or any other desired frequency). Radio-frequency signals 44 may sometimes be referred to as radiative near-field signals or Fresnel near-field signals.

Rectifier circuitry 50 converts received radio-frequency signals 44 (sometimes referred to as wireless power signals 44 or wireless charging signals 44) from antenna(s) 140 into DC voltage signals for powering device 24. The DC voltages produced by rectifier 50 can be used in powering a battery such as battery 58 and can be used in powering other components in device 24. For example, device 24 may include input-output devices 56. Input-output devices 56 may include user interface devices, data port devices, and other input-output components. For example, input-output devices 56 may include touch screens, displays without touch sensor capabilities, buttons, joysticks, scrolling wheels, touch pads, key pads, keyboards, microphones, cameras, buttons, speakers, status indicators, light sources, audio jacks and other audio port components, digital data port devices, light sensors, position and orientation sensors (e.g., sensors such as accelerometers, gyroscopes, and compasses), capacitance sensors, proximity sensors (e.g., capacitive proximity sensors, light-based proximity sensors, etc.), and/or fingerprint sensors. Input-output devices 56 may be powered by the DC voltages produced by rectifier 50 (and/or DC voltages produced by battery 58).

Control circuitry 16 may be used to run software on wireless power transmitting device 12, such as internet browsing applications, voice-over-internet-protocol (VOIP) telephone call applications, email applications, media playback applications, operating system functions, etc. To support interactions with external equipment, control circuitry 16 may be used in implementing communications protocols. Communications protocols that may be implemented using control circuitry 16 include internet protocols, wireless local area network protocols (e.g., IEEE 802.11 protocols—sometimes referred to as WiFi®), protocols for other short-range wireless communications links such as the Bluetooth® protocol, cellular telephone protocols, multiple-input and multiple-output (MIMO) protocols, antenna diversity protocols, satellite navigation system protocols, millimeter wave communications protocols, IEEE 802.15.4 ultra-wideband communications protocols, etc.

Control circuitry 16 may include radio-frequency (RF) transceiver circuitry such as radio-frequency transceiver circuitry 42 formed from one or more integrated circuits, power amplifier circuitry, low-noise input amplifiers, passive RF components, one or more antennas, transmission lines, and other circuitry for handling RF wireless signals. Wireless signals can also be sent using light (e.g., using infrared communications). Control circuitry 16 may use radio-frequency transceiver circuitry 42 to handle various radio-frequency communications bands.

Transceiver circuitry 42 may handle 2.4 GHz and 5 GHz bands for WiFi® (IEEE 802.11) communications and may handle the 2.4 GHz Bluetooth® communications band. Transceiver circuitry 42 may handle wireless communications in frequency ranges such as a low communications band from 700 to 960 MHz, a low-midband from 960 to 1710 MHz, a midband from 1710 to 2170 MHz, a high band from 2300 to 2700 MHz, an ultra-high band from 3400 to 3700 MHz or other communications bands between 600 MHz and 4000 MHz or other suitable frequencies (as examples). Transceiver circuitry 42 may handle voice data and non-voice data. For example, transceiver circuitry 42 may include circuitry for receiving television and radio signals, paging system transceivers, near field communications (NFC) circuitry, etc. Transceiver circuitry 42 may include global positioning system (GPS) receiver equipment for receiving GPS signals at 1575 MHz or for handling other satellite positioning data. In WiFi® and Bluetooth® links and other short-range wireless links, wireless signals are typically used to convey data over tens or hundreds of feet. In cellular telephone links and other long-range links, wireless signals are typically used to convey data over thousands of feet or miles. Transceiver circuitry 42 may also handle communications of wireless charging signals (e.g., signals 44) at any desired frequency (e.g., 900 MHz, between 850 and 950 MHz, between 800 and 1000 MHz, greater than 500 MHz, less than 400 MHz, 2400 MHz, between 2400 and 2500 MHz, 5 GHz, between 5000 MHz and 6000 MHz, between 500 MHz and 6000 MHz, or any other desired frequency).

Antennas 40 in power transmitting device 12 may be formed using any suitable antenna types. For example, antennas 40 may include antennas with resonating elements that are formed from stacked patch antenna structures, loop antenna structures, patch antenna structures, inverted-F antenna structures, slot antenna structures, planar inverted-F antenna structures, monopoles, dipoles, helical antenna structures, Yagi (Yagi-Uda) antenna structures, hybrids of these designs, etc. If desired, one or more of antennas 40 may be cavity-backed antennas. Different types of antennas may be used for different bands and combinations of bands. For example, one type of antenna may be used in forming a local wireless link antenna and another type of antenna may be used in forming a remote wireless link antenna. Dedicated antennas may be used for receiving satellite navigation system signals or, if desired, antennas 40 can be configured to receive both satellite navigation system signals and signals for other communications bands (e.g., wireless local area network signals and/or cellular telephone signals). Antennas 40 can include one or more antennas for handling transfer of wireless power signals.

Transmission line paths may be used to route antenna signals within device 12. For example, transmission line paths may be used to couple antenna structures 40 to transceiver circuitry 42. Transmission lines in device 12 may include coaxial probes realized by metalized vias, microstrip transmission lines, stripline transmission lines, edge-coupled microstrip transmission lines, edge-coupled stripline transmission lines, waveguide structures, transmission lines formed from combinations of transmission lines of these types, etc. Transmission lines in device 12 may be integrated into rigid and/or flexible printed circuit boards. In one suitable arrangement, transmission lines in device 12 may also include transmission line conductors (e.g., signal and ground conductors) integrated within multilayer laminated structures (e.g., layers of a conductive material such as copper and a dielectric material such as a resin that are laminated together without intervening adhesive) that may be folded or bent in multiple dimensions (e.g., two or three dimensions) and that maintain its bent or folded shape after bending (e.g., the multilayer laminated structures may be folded into a particular three-dimensional shape to route around other device components and may be rigid enough to hold its shape after folding without being held in place by stiffeners or other structures). All of the multiple layers of the laminated structures may be batch laminated together (e.g., in a single pressing process) without adhesive (e.g., as opposed to performing multiple pressing processes to laminate multiple layers together with adhesive). Filter circuitry, switching circuitry, impedance matching circuitry, and other circuitry may be interposed within the transmission lines, if desired.

Control circuitry 30 may be used to run software on wireless power transmitting device 24, such as internet browsing applications, voice-over-internet-protocol (VOIP) telephone call applications, email applications, media playback applications, operating system functions, etc. To support interactions with external equipment, control circuitry 30 may be used in implementing communications protocols. Communications protocols that may be implemented using control circuitry 30 include internet protocols, wireless local area network protocols (e.g., IEEE 802.11 protocols—sometimes referred to as WiFi®), protocols for other short-range wireless communications links such as the Bluetooth® protocol, cellular telephone protocols, multiple-input and multiple-output (MIMO) protocols, antenna diversity protocols, satellite navigation system protocols, millimeter wave communications protocols, IEEE 802.15.4 ultra-wideband communications protocols, etc.

Control circuitry 30 may include radio-frequency (RF) transceiver circuitry such as radio-frequency transceiver circuitry 46 formed from one or more integrated circuits, power amplifier circuitry, low-noise input amplifiers, passive RF components, one or more antennas, transmission lines, and other circuitry for handling RF wireless signals. Wireless signals can also be sent using light (e.g., using infrared communications). Control circuitry 30 may use radio-frequency transceiver circuitry 46 to handle various radio-frequency communications bands.

Transceiver circuitry 46 may handle 2.4 GHz and 5 GHz bands for WiFi® (IEEE 802.11) communications and may handle the 2.4 GHz Bluetooth® communications band. Transceiver circuitry 46 may handle wireless communications in frequency ranges such as a low communications band from 700 to 960 MHz, a low-midband from 960 to 1710 MHz, a midband from 1710 to 2170 MHz, a high band from 2300 to 2700 MHz, an ultra-high band from 3400 to 3700 MHz or other communications bands between 600 MHz and 4000 MHz or other suitable frequencies (as examples). Transceiver circuitry 46 may handle voice data and non-voice data. For example, transceiver circuitry 46 may include circuitry for receiving television and radio signals, paging system transceivers, near field communications (NFC) circuitry, etc. Transceiver circuitry 46 may include global positioning system (GPS) receiver equipment for receiving GPS signals at 1575 MHz or for handling other satellite positioning data. In WiFi® and Bluetooth® links and other short-range wireless links, wireless signals are typically used to convey data over tens or hundreds of feet. In cellular telephone links and other long-range links, wireless signals are typically used to convey data over thousands of feet or miles. Transceiver circuitry 46 may also handle communications of wireless charging signals (e.g., signals 44) at any desired frequency (e.g., 900 MHz, between 850 and 950 MHz, between 800 and 1000 MHz, greater than 500 MHz, less than 400 MHz, 2400 MHz, between 2400 and 2500 MHz, 5 GHz, between 5000 MHz and 6000 MHz, between 500 MHz and 6000 MHz, or any other desired frequency).

Antennas 140 in power transmitting device 24 may be formed using any suitable antenna types. For example, antennas 140 may include antennas with resonating elements that are formed from stacked patch antenna structures, loop antenna structures, patch antenna structures, inverted-F antenna structures, slot antenna structures, planar inverted-F antenna structures, monopoles, dipoles, helical antenna structures, Yagi (Yagi-Uda) antenna structures, hybrids of these designs, etc. If desired, one or more of antennas 140 may be cavity-backed antennas. Different types of antennas may be used for different bands and combinations of bands. For example, one type of antenna may be used in forming a local wireless link antenna and another type of antenna may be used in forming a remote wireless link antenna. Dedicated antennas may be used for receiving satellite navigation system signals or, if desired, antennas 140 can be configured to receive both satellite navigation system signals and signals for other communications bands (e.g., wireless local area network signals and/or cellular telephone signals). Antennas 140 can include one or more antennas for handling transfer of wireless power signals.

Transmission line paths may be used to route antenna signals within device 24. For example, transmission line paths may be used to couple antenna structures 140 to transceiver circuitry 46. Transmission lines in device 24 may include coaxial probes realized by metalized vias, microstrip transmission lines, stripline transmission lines, edge-coupled microstrip transmission lines, edge-coupled stripline transmission lines, waveguide structures, transmission lines formed from combinations of transmission lines of these types, etc. Transmission lines in device 24 may be integrated into rigid and/or flexible printed circuit boards. In one suitable arrangement, transmission lines in device 24 may also include transmission line conductors (e.g., signal and ground conductors) integrated within multilayer laminated structures (e.g., layers of a conductive material such as copper and a dielectric material such as a resin that are laminated together without intervening adhesive) that may be folded or bent in multiple dimensions (e.g., two or three dimensions) and that maintain its bent or folded shape after bending (e.g., the multilayer laminated structures may be folded into a particular three-dimensional shape to route around other device components and may be rigid enough to hold its shape after folding without being held in place by stiffeners or other structures). All of the multiple layers of the laminated structures may be batch laminated together (e.g., in a single pressing process) without adhesive (e.g., as opposed to performing multiple pressing processes to laminate multiple layers together with adhesive). Filter circuitry, switching circuitry, impedance matching circuitry, and other circuitry may be interposed within the transmission lines, if desired.

Device 12 and/or device 24 may communicate wirelessly using in-band or out-of-band communications. Device 12 may, for example, use wireless transceiver circuitry 42 to wirelessly transmit out-of-band signals (e.g., radio-frequency signals at a different frequency from wireless power signals 44) to device 24 using an antenna. Wireless transceiver circuitry 42 may be used to wirelessly receive out-of-band signals from device 24 using antennas 40. Device 24 may use wireless transceiver circuitry 46 to transmit out-of-band signals to device 12. Receiver circuitry in wireless transceiver 46 may use an antenna to receive out-of-band signals from device 12. Wireless power transmitting device 12 and wireless power receiving device 24 may also communicate using in-band signals (e.g., frequency-shift keying (FSK) and/or amplitude-shift keying (ASK) may be used to communicate signals during the transfer of wireless power 44).

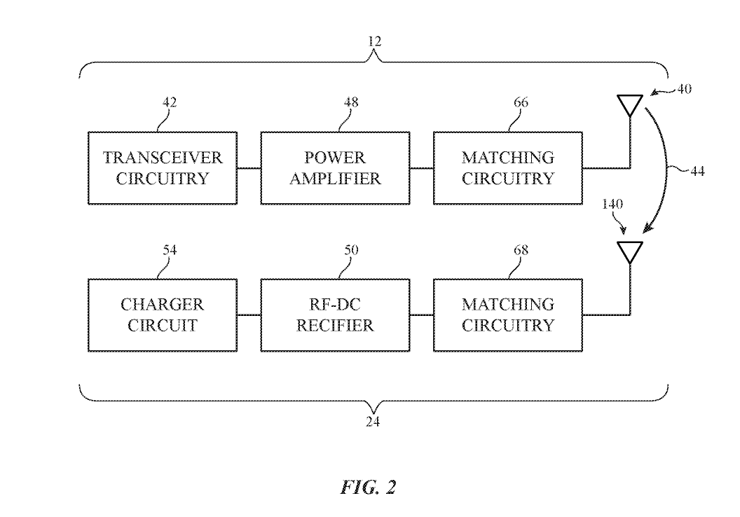

FIG. 2 is a schematic diagram showing how wireless charging signals 44 may be transferred from antenna 40 of wireless power transmitting device 12 to antenna 140 of wireless power receiving device 24. As shown, transceiver circuitry 42 may generate radio-frequency signals that are used to wirelessly transfer power. The signals from transceiver circuitry 42 may be amplified by power amplifier 48. Matching circuitry 66 may also be coupled to antenna 40. Matching circuitry 66 (sometimes referred to as a matching network) may be an adjustable matching network formed using tunable components. Matching circuitry 66 may include components such as inductors, resistors, and capacitors used in matching the impedance of antenna 40 to the impedance of a transmission line used to convey signals from transceiver circuitry 42 to antenna 40. Matching network components may be provided as discrete components (e.g., surface mount technology components) or may be formed from housing structures, printed circuit board structures, traces on plastic supports, etc. Components such as these may also be used in forming filter circuitry in antenna(s) 40 and may be tunable and/or fixed components.

Antenna 40 may transmit radio-frequency signals 44 to antenna 140. Antenna 140 may also be coupled to matching circuitry such as matching circuitry 68. Matching circuitry 68 (sometimes referred to as a matching network) may be an adjustable matching network formed using tunable components. Matching circuitry 68 may include components such as inductors, resistors, and capacitors used in matching the impedance of antenna 140 to the impedance of a transmission line used to convey signals from antenna 140 to rectifier circuitry 50. Matching network components may be provided as discrete components (e.g., surface mount technology components) or may be formed from housing structures, printed circuit board structures, traces on plastic supports, etc. Components such as these may also be used in forming filter circuitry in antenna(s) 140 and may be tunable and/or fixed components.

The radio-frequency signals received by antenna 140 may be provided to radio-frequency direct-current (RF-DC) rectifier (e.g., rectifier circuitry) 50. Rectifier 50 may convert the radio-frequency signals received by antenna 140 into direct-current power that is provided to charger circuit 54 (e.g., power receiving circuitry). The charger circuit may receive power from rectifier 50 and charge battery 58 of the power receiving device 24 using the received power. The charger circuit may optionally be disconnected from the battery to stop charging the battery (even if power is still being received from an external power source). When the charger circuit is disconnected from the battery, the control circuitry and other components within power receiving device 24 may be powered by power from the external power source (e.g., power transmitting device 12).

To maximize the transfer of wireless power between power transmitting device 12 and power receiving device 24, a coupling efficiency between antenna 40 of device 12 and antenna 140 of device 24 may be maximized. To maximize coupling efficiency, path loss between antennas 40 and 140 may be minimized (e.g., less than 30 dB, less than 25 dB, less than 20 dB, between 20 dB and 30 dB, etc.).

As previously discussed, antennas 40 and 140 may be any desired type of antennas (e.g., antennas with resonating elements that are formed from stacked patch antenna structures, loop antenna structures, patch antenna structures, inverted-F antenna structures, slot antenna structures, planar inverted-F antenna structures, monopoles, dipoles, helical antenna structures, Yagi antenna structures, hybrids of these designs, etc.). If desired, antenna 40 and/or antenna 140 may be cavity-backed antennas.

In some arrangements, wireless power receiving device 24 may be an electronic device accessory. For example, device 24 may be a keyboard, trackpad, or mouse that may be used with a desktop computer. The electronic device accessory may wirelessly communicate with the desktop computer during use. Desktop computers are typically coupled to a wall outlet, whereas electronic device accessories may operate wirelessly (and therefore not be coupled to an external power source during use). In these types of arrangements, it may be challenging to keep the electronic device accessory sufficiently charged. Therefore, the desktop computer (e.g., device 12) may be configured to wirelessly transfer power to the electronic device accessory (e.g., device 24).

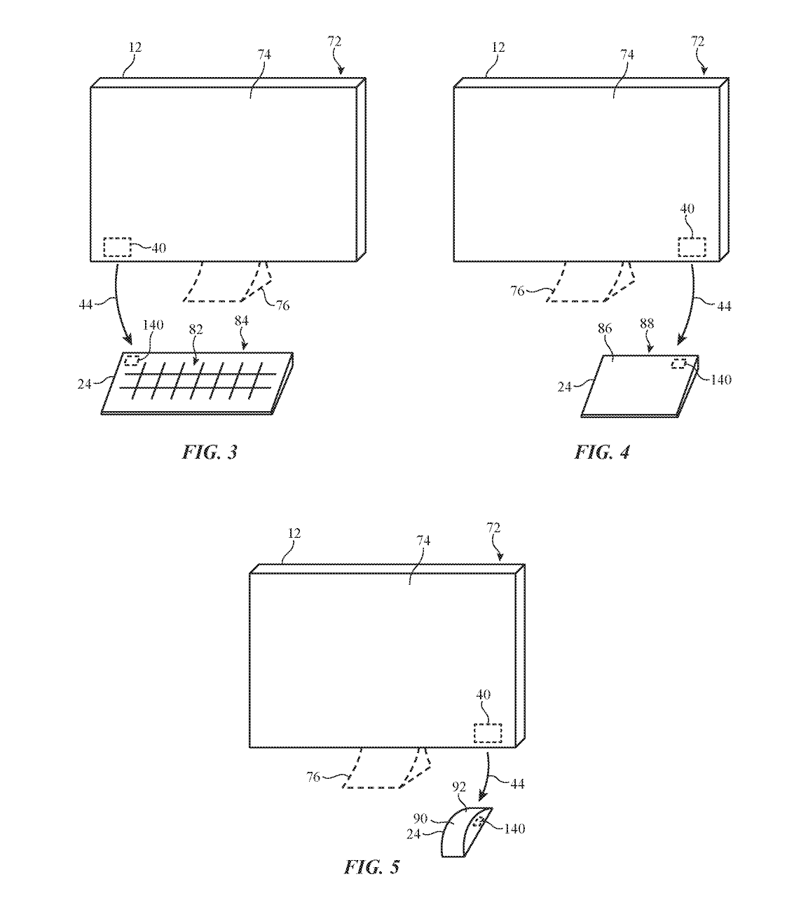

FIGS. 3-5 are schematic diagrams of wireless power systems that include a desktop computer and an electronic device accessory. In FIG. 3, wireless power transmitting device 12 is a desktop computer and wireless power receiving device 24 is a keyboard. The desktop computer may include a housing 72. In this type of arrangement, housing 72 for device 12 may be mounted on a support structure such as stand 76 or stand 76 may be omitted (e.g., to mount device 12 on a wall). Display 74 may be mounted on a front face of housing 12. Stand 76 may be connected to the center of housing 72 on an opposing rear face of device 10 (e.g., by a fixed attachment structure, a hinge, etc.).

The keyboard (24) may include keys such as keys 82 on a front face of the keyboard. The keyboard may also include an input-output port such as input-output port 84 (e.g., an audio jacks or other audio port, a digital data port, etc.). Input-output port 84 may be configured to receive an external mating connector. If desired, input-output port 84 may be used to connect to an external power source (e.g., input-output port 84 may be a charging port). Input to keys 82 of the keyboard may be used to control the desktop computer. Keys 82 may be oriented to face a user during use (e.g., each key may have a respective glyph that is oriented to face the user during use).

The desktop computer (12) and keyboard (24) of FIG. 3 may include antennas to enable wireless power transfer. Antenna 40 in the desktop computer may transfer radio-frequency signals 44 to antenna 140 in the keyboard. The keyboard may then use rectifier circuitry (50) to convert the radio-frequency signals to wireless power. The wireless charging signals 44 may be conveyed at any desired frequency (e.g., 900 MHz, between 880 and 920 MHz, between 850 and 950 MHz, between 800 and 1000 MHz, greater than 500 MHz, less than 400 MHz, 2400 MHz, between 2400 and 2500 MHz, 5 GHz, between 5000 MHz and 6000 MHz, between 500 MHz and 6000 MHz, or any other desired frequency).

In addition to transferring radio-frequency signals for wireless power transfer, the desktop computer and keyboard may include additional antennas for transmitting additional wireless information (e.g., information regarding user input to the keyboard). The additional wireless information may be conveyed in a 2.4 GHz Bluetooth® communications band or any other desired communications band. Alternatively, the antennas used for transferring wireless power may also be used for conveying the additional wireless communication.

In FIG. 4, wireless power transmitting device 12 is a desktop computer (as described in connection with FIG. 3). However, wireless power receiving device 24 in FIG. 4 is a trackpad (sometimes referred to as a touchpad). The trackpad (24) may have a touch sensitive surface 86 (e.g., device 24 may include touch sensors of any desired type under surface 86). Input to the touch sensitive surface of the trackpad may be used to control a cursor or other components of the desktop computer (12), as an example. The trackpad may also include an input-output port such as input-output port 88 (e.g., a digital data port). Input-output port 88 may be configured to receive an external mating connector. If desired, input-output port 88 may be used to connect to an external power source (e.g., input-output port 88 may be a charging port).

The desktop computer (12) and trackpad (24) of FIG. 4 may include antennas to enable wireless power transfer. Antenna 40 in the desktop computer may transfer radio-frequency signals 44 to antenna 140 in the trackpad. The trackpad may then use rectifier circuitry (50) to convert the radio-frequency signals to wireless power. The wireless charging signals 44 may be conveyed at any desired frequency (e.g., 900 MHz, between 880 and 920 MHz, between 850 and 950 MHz, between 800 and 1000 MHz, greater than 500 MHz, less than 400 MHz, between 500 MHz and 6000 MHz, or any other desired frequency).

In addition to transferring radio-frequency signals for wireless power transfer, the desktop computer and trackpad may include additional antennas for transmitting additional wireless information (e.g., information regarding user input to the trackpad). The additional wireless information may be conveyed in a 2.4 GHz Bluetooth® communications band or any other desired communications band. Alternatively, the antennas used for transferring wireless power may also be used for conveying the additional wireless communication.

In FIG. 5, wireless power transmitting device 12 is a desktop computer (as described in connection with FIG. 3). However, wireless power receiving device 24 in FIG. 5 is a mouse. The mouse (24) may have a touch sensitive surface 90 (e.g., device 24 may include touch sensors of any desired type under surface 90). The mouse may also include a button such as button 92. The mouse may also include a sensor on a bottom surface that detects how the mouse is moved along an underlying surface. Input to the button, sensor, and touch sensor in the mouse may be used to control a cursor or other components of the desktop computer (12), as an example. The mouse may also include an input-output port if desired.

The desktop computer (12) and mouse (24) of FIG. 5 may include antennas to enable wireless power transfer. Antenna 40 in the desktop computer may transfer radio-frequency signals 44 to antenna 140 in the mouse. The mouse may then use rectifier circuitry (50) to convert the radio-frequency signals to wireless power. The wireless power signals 44 may be conveyed at any desired frequency (e.g., 900 MHz, between 880 and 920 MHz, between 850 and 950 MHz, between 800 and 1000 MHz, greater than 500 MHz, less than 400 MHz, between 500 MHz and 6000 MHz, or any other desired frequency).

In addition to transferring radio-frequency signals for wireless power transfer, the desktop computer and mouse may include additional antennas for transmitting additional wireless information (e.g., information regarding user input to the mouse). The additional wireless information may be conveyed in a 2.4 GHz Bluetooth® communications band or any other desired communications band. Alternatively, the antennas used for transferring wireless power may also be used for conveying the additional wireless communication.

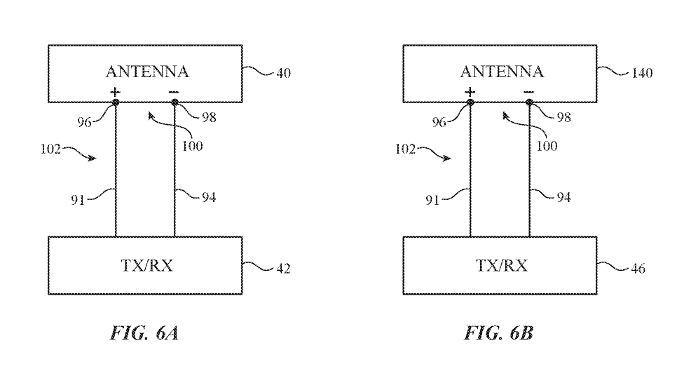

A schematic diagram of a given antenna 40 coupled to transceiver circuitry 42 is shown in FIG. 6A, whereas a schematic diagram of a given antenna 140 coupled to transceiver circuitry 46 is shown in FIG. 6B. As shown in FIG. 6A, radio-frequency transceiver circuitry 42 may be coupled to antenna feed 100 of antenna 40 using transmission line 102. Antenna feed 100 may include a positive antenna feed terminal such as positive antenna feed terminal 96 and may include a ground antenna feed terminal such as ground antenna feed terminal 98. Transmission line 102 may be formed form metal traces on a printed circuit or other conductive structures and may have a positive transmission line signal path such as path 91 that is coupled to terminal 96 and a ground transmission line signal path such as path 94 that is coupled to terminal 98. Transmission line paths such as path 102 may be used to route antenna signals within device 12. For example, transmission line paths may be used to couple antenna structures such as one or more antennas to transceiver circuitry 42. Transmission lines in device 12 may include coaxial probes realized by metal vias, microstrip transmission lines, stripline transmission lines, edge-coupled microstrip transmission lines, edge-coupled stripline transmission lines, waveguide structures, transmission lines formed from combinations of transmission lines of these types, etc. Transmission lines in device 12 may be integrated into rigid and/or flexible printed circuit boards. In one suitable arrangement, transmission lines in device 12 may also include transmission line conductors (e.g., signal and ground conductors) integrated within multilayer laminated structures (e.g., layers of a conductive material such as copper and a dielectric material such as a resin that are laminated together without intervening adhesive) that may be folded or bent in multiple dimensions (e.g., two or three dimensions) and that maintain its bent or folded shape after bending (e.g., the multilayer laminated structures may be folded into a particular three-dimensional shape to route around other device components and may be rigid enough to hold its shape after folding without being held in place by stiffeners or other structures). Filter circuitry, switching circuitry, impedance matching circuitry (e.g., matching circuitry 66), and other circuitry may be interposed within transmission line 102 and/or circuits such as these may be incorporated into antenna 40 if desired (e.g., to support antenna tuning, to support operation in desired frequency bands, etc.). As shown in FIG. 6B, antenna 140 may be coupled to transceiver circuitry 46 by similar structures as described in connection with FIG. 6A.

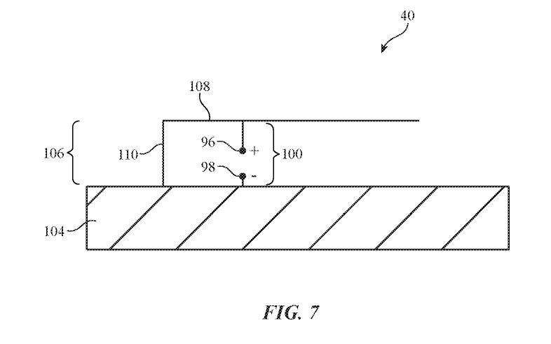

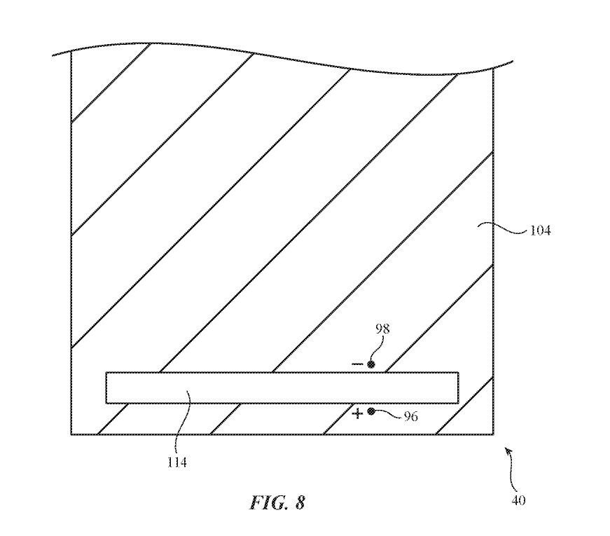

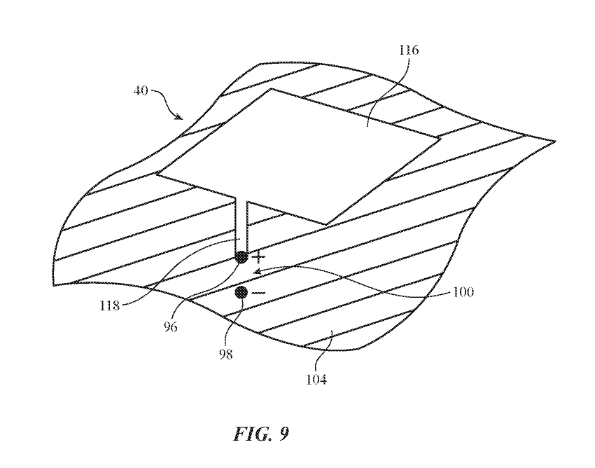

FIG. 7 is a diagram of illustrative inverted-F antenna structures that may be used in implementing a given antenna (e.g., antenna 40 or antenna 140) in wireless power system 8. Inverted-F antenna 40 of FIG. 7 has antenna resonating element 106 and antenna ground (ground plane) 104. Antenna ground 104 may be formed from housing structures such as a conductive support plate, printed circuit traces, conductive portions of a display, metal portions of electronic components, or other conductive ground structures. Antenna resonating element 106 may have a main resonating element arm such as arm 108. The length of arm 108 and/or portions of arm 108 may be selected so that antenna 40 resonates at desired operating frequencies. For example, the length of arm 108 may be a quarter of a wavelength at a desired operating frequency for antenna 40. Antenna 40 may also exhibit resonances at harmonic frequencies.

Main resonating element arm 108 may be coupled to ground 104 by return path 110. An inductor or other component may be interposed in path 110 and/or tunable components may be interposed in path 110 and/or coupled in parallel with path 110 between arm 108 and ground 104. If desired, tuning components may be adjusted to interpose a selected one of a number of different inductors in path 110. Additional return paths 110 may be coupled between arm 108 and ground 104 if desired.

Antenna 40 may be fed using one or more antenna feeds. For example, antenna 40 may be fed using antenna feed 100. Antenna feed 100 may include positive antenna feed terminal 96 and ground antenna feed terminal 98 and may run in parallel to return path 110 between arm 108 and ground 104. If desired, inverted-F antennas such as illustrative antenna 40 of FIG. 7 may have more than one resonating arm branch (e.g., to create multiple frequency resonances to support operations in multiple communications bands) or may have other antenna structures (e.g., parasitic antenna resonating elements, tunable components to support antenna tuning, etc.). For example, arm 108 may have left and right branches that extend outwardly from feed 100 and return path 110. Multiple feeds may be used to feed antennas such as antenna 40.

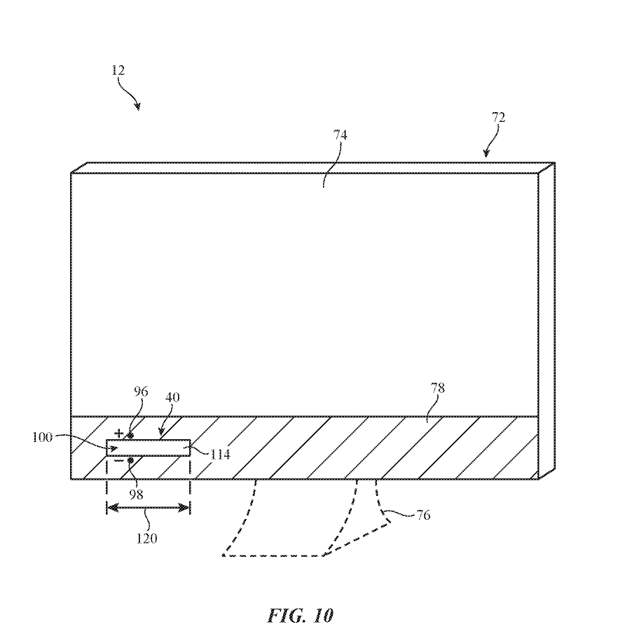

FIG. 8 is a diagram of illustrative slot antenna structures that may be used in implementing a given antenna (e.g., antenna 40 or antenna 140) in wireless power system 8. As shown in FIG. 8, for example, antenna 40 may be based on a slot antenna configuration having an opening such as slot 114 that is formed within conductive structures such as antenna ground 104. In the configuration of FIG. 8, slot 114 is a closed slot, because portions of antenna ground 104 completely surround and enclose slot 114. Open slot antennas may also be formed in conductive materials such as antenna ground 104 (e.g., by forming an opening in the right-hand or left-hand end of antenna ground 104 so that slot 114 protrudes through antenna ground 104). Antenna ground 104 may be formed from housing structures such as a conductive support plate, printed circuit traces, conductive portions of a display, metal portions of electronic components, or other conductive ground structures. Slot 114 may be filled with air, plastic, and/or other dielectric. The shape of slot 114 may be straight or may have one or more bends (e.g., slot 114 may have an elongated shape following a meandering path). The antenna feed for antenna 40 may include positive antenna feed terminal 96 and ground antenna feed terminal 98. Feed terminals 96 and 98 may, for example, be located on opposing sides of slot 114 (e.g., on opposing long sides of slot 114). Slot 114 of FIG. 8 (sometimes referred to herein as slot antenna resonating element 114, slot resonating element 114, or slot element 114) may give rise to an antenna resonance at frequencies around a center frequency in which the wavelength of operation of the antenna is approximately equal to the perimeter of the slot. In narrow slots, the length of the slot may be approximately equal to half of the corresponding wavelength of operation. Harmonic modes of slot 114 may also be configured to cover desired frequency bands. In scenarios where slot 114 is an open slot, the length of slot 104 may be approximately equal to one quarter of the wavelength of operation of antenna 40. If desired, the frequency response of antenna 40 can be tuned using one or more tunable components such as tunable inductors or tunable capacitors. These components may have terminals that are coupled to opposing sides of the slot (e.g., the tunable components may bridge the slot). If desired, tunable components may have terminals that are coupled to respective locations along the length of one of the sides of slot 114. Combinations of these arrangements may also be used.

FIG. 9 is a diagram of illustrative patch antenna structures that may be used in implementing a given antenna (e.g., antenna 40 or antenna 140) in wireless power system 8. As shown in FIG. 9, patch antenna 40 may have a patch antenna resonating element 116 that is separated from and parallel to a ground plane such as antenna ground plane 104. Antenna ground 104 may be formed from housing structures such as a conductive support plate, printed circuit traces, conductive portions of a display, metal portions of electronic components, or other conductive ground structures. Arm 118 may be coupled between patch antenna resonating element 116 and positive antenna feed terminal 96 of antenna feed 80. Ground antenna feed terminal 98 of feed 100 may be coupled to ground plane 104.

FIG. 10 is a diagram of an illustrative wireless power transmitting device 12 that is a desktop computer. The desktop computer includes a slot antenna such as slot antenna 40. As shown, housing 72 of the desktop computer has a conductive portion 78. Conductive portion 78 may, for example, be formed on a front face of the desktop computer below display 74. In some arrangements a transparent layer (e.g., cover glass) over display 74 may rest on an upper edge of conductive portion 78. Conductive portion 78 may therefore sometimes be referred to as a chin region. Antenna 40 may include a slot 114 in conductive housing portion 78. The conductive housing portion may serve as an antenna ground for slot antenna 40. Feed 100 may be coupled across slot 114. Slot 114 may have a length 120 that is approximately equal (e.g., within 15%) to half of a wavelength of the radio-frequency signals transmitted by slot antenna 40. If desired, conductive portion 78 may form an exterior surface of device 12. Alternatively, a layer (e.g., a display cover layer or other dielectric cover) may cover conductive portion 78 and form an exterior surface of device 12.

The arrangement of FIG. 10 where slot 114 is formed in a conductive portion of housing 72 is merely illustrative. If desired, slot 114 may be formed in any desired conductive component of power transmitting device 12.

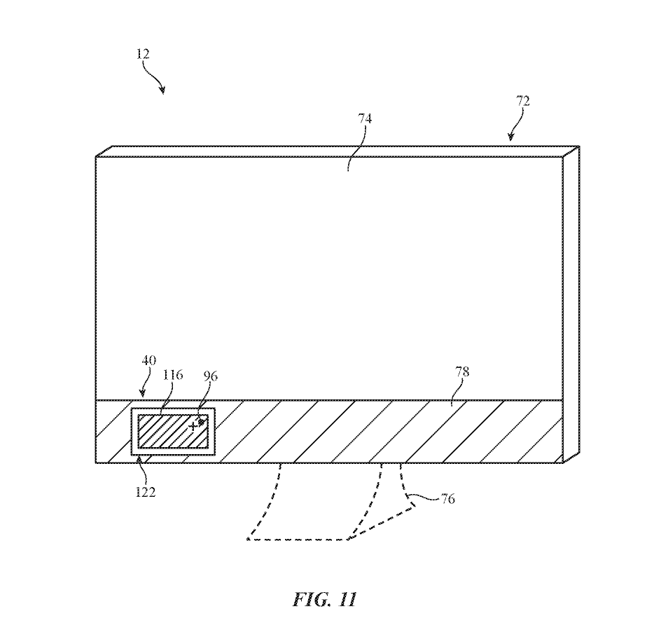

The example of FIG. 10 where antenna 40 in wireless power transmitting device 12 is a slot antenna is merely illustrative. In another arrangement shown in FIG. 11, antenna 40 in wireless power transmitting device 12 (a desktop computer) is a patch antenna. The patch antenna may include a patch antenna resonating element 116 coupled to positive antenna feed terminal 96. The patch antenna resonating element 116 may be formed in an opening 122 in conductive housing portion 78.

The arrangement of FIG. 11 where patch antenna resonating element 116 is formed in an opening in a conductive portion of housing 72 is merely illustrative. If desired, patch antenna resonating element 116 may be formed from or in any desired conductive component of power transmitting device 12.

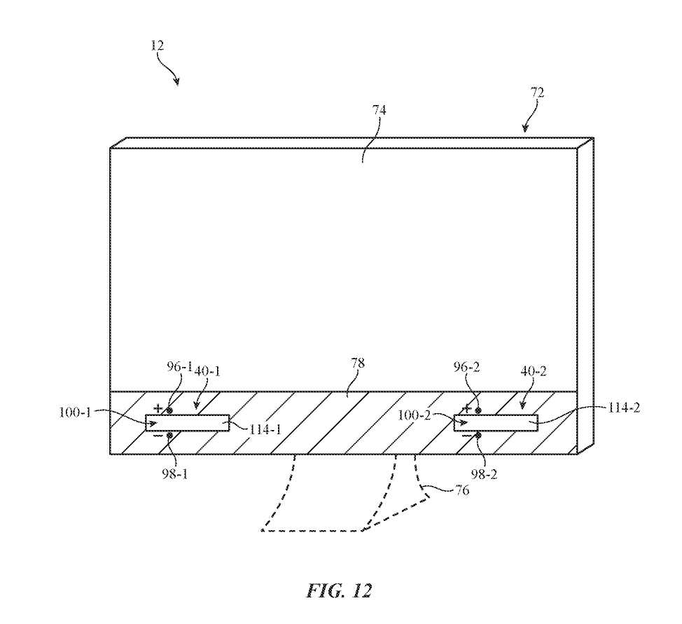

The example of FIGS. 10 and 11 where wireless power transmitting device 12 has one antenna 40 to transfer wireless power are merely illustrative. If desired, wireless power transmitting device 12 may have two or more antennas to transfer wireless power. An example is shown in FIG. 12 where wireless power transmitting device 12 (a desktop computer) has two antennas (40-1 and 40-2) for wireless power transfer. Antenna 40-1 includes a slot 114-1 in conductive housing portion 78. The conductive housing portion may serve as an antenna ground for slot antenna 40-1. Feed 100-1 may be coupled across slot 114-1. Antenna 40-2 includes a slot 114-2 in conductive housing portion 78. The conductive housing portion may serve as an antenna ground for slot antenna 40-2. Feed 100-2 may be coupled across slot 114-2.

Including two antennas for wireless power transfer may increase the maximum possible amount of wireless power that can be transferred to a corresponding wireless power receiving device. Including multiple antennas may also make the wireless power transfer more robust to changes in location of the wireless power receiving device.

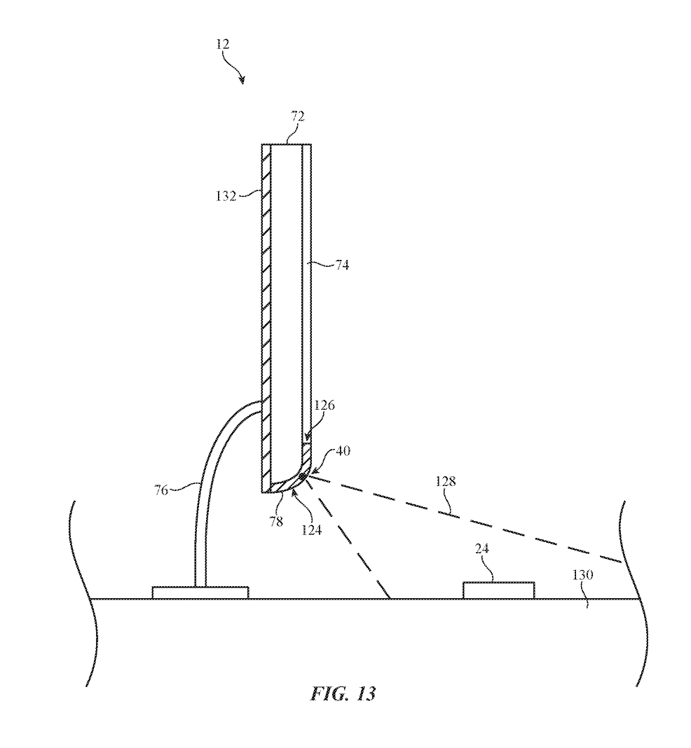

If desired, antenna 40 in wireless power transmitting device 12 may be arranged to direct wireless power signals 44 to an expected location of wireless power receiving device 24. FIG. 13 shows an illustrative wireless power transmitting device 12 with an antenna on a curved surface to direct wireless power signals towards wireless power receiving device 24. The expected location of wireless power receiving device 24 may be on surface 130 in front of the front face of the desktop computer. As shown in FIG. 13, wireless power transmitting device 12 (a desktop computer) may include antenna 40 on a curved surface 124 (sometimes referred to as a curved wall or curved housing wall) of conductive housing portion 78. Antenna 40 may emit radio-frequency signals 44 across a field-of-view 128. Because antenna 40 is on a curved portion of the front face of the desktop computer, the radio-frequency signals may be directed to the expected location of wireless power receiving device 24. If desired, other beam steering techniques may be used to direct radio-frequency signals 44 from power transmitting device 12 to power receiving device 24.

As shown in FIG. 13, a portion of display 74 (e.g., a cover glass) may rest on upper edge 126 of conductive housing portion 78. Additionally, device 12 may include a reflective layer 132 on a rear face (e.g., opposite display 74). Reflective layer 132 may be formed from a conductive material and may help form a cavity for radio-frequency signals transmitted from antenna 40. Reflective layer 132 may be electrically connected to conductive housing portion 78 (as shown in FIG. 13). However, this example is merely illustrative. Reflective layer 132 may not be electrically connected to conductive housing portion 78 or may be formed integrally with conductive housing portion 78 (e.g., reflective layer 132 and conductive housing portion 78 may be formed from a unitary piece of metal).

Including reflective layer 132 to help form a cavity (e.g., a cavity defined by reflective layer 132 and conductive housing portion 78) for radio-frequency signals transmitted from antenna 40 may improve antenna gain, directionality of the radio-frequency signals towards the wireless power receiving device, and Fresnel near-field radiative efficiency. This in turn optimizes wireless coupling efficiency between antenna 40 in the wireless power transmitting device and an antenna in wireless power receiving device 24 and thus end-to-end charging efficiency.

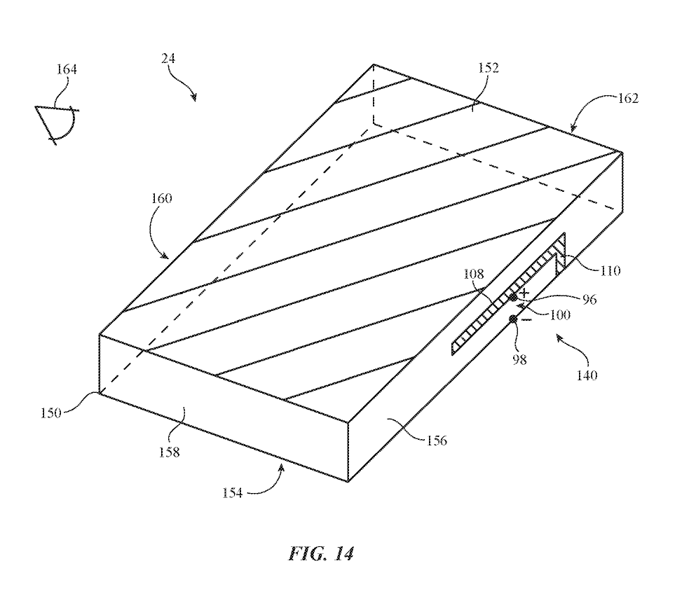

FIG. 14 is a diagram of an illustrative wireless power receiving device with an inverted-F antenna. As shown in FIG. 14, antenna 140 in wireless power receiving device 24 may include a resonating element arm such as arm 108. Antenna resonating element arm 108 may be coupled to ground by return path 110. Antenna 140 may have a feed 100 including a positive antenna feed terminal 96 coupled to antenna resonating element arm 108 and a ground antenna feed terminal 98 coupled to a conductive layer of wireless power receiving device 24.

The wireless power receiving device in FIG. 14 has a housing 150 with an upper surface 152 and lower surface 154 that are connected by edge surfaces 156, 158, 160, and 162 (e.g., sidewalls). Edge surfaces 156, 158, 160, and 162 may be substantially parallel (e.g., within)15° if desired. Upper surface 152 and lower surface 154 may be conductive. Edge surfaces 156, 158, 160, and 162 may be dielectric. Antenna resonating element arm 108 and return path 110 may be formed on (or behind) dielectric edge surface 156. Ground terminal 98 may be coupled to conductive lower surface 154. Conductive lower surface 154 may therefore serve as at least a portion of antenna ground 104 (FIG. 7). Conductive lower surface 154 and conductive upper surface 152 may form a cavity for antenna 140 to improve the antenna gain, coupling efficiency between wireless power receiving device 24 and power transmitting device 12, and end-to-end charging efficiency. If desired, one or more of edge surfaces 158, 160, and 162 may also be conductive. When conductive, one or more of edge surfaces 158, 160, and 162 may form a portion of a cavity for antenna 140 (e.g., surfaces 152, 154, 158, 160, and 162 may define a cavity for antenna 140).

Any desired components may be included in housing 150. In various embodiments, wireless power receiving device 24 in FIG. 14 may be a keyboard or a trackpad. When wireless power receiving device 24 is a keyboard, keys (e.g., keys 82 in FIG. 3) may be formed on or adjacent to conductive upper surface 152 of device 24. Upper surface 152 may have openings to accommodate the keys if desired. The keys of the keyboard (24) may be configured to be viewed by a user 164 on a first side (e.g., front side) of the keyboard. In other words, edge surface 160 may define the front of the keyboard whereas edge surface 156 may define the back of the keyboard. Each key of the keyboard may have a respective glyph that is orientated to face the front (e.g., edge 160) of the keyboard. The inverted-F antenna resonating element 108 may be formed on the back edge surface (156) of the housing. The edge surface 156 (with resonating element arm 108) of the keyboard may be closer to the desktop computer (12) during use than edge surface 160. This arrangement for a keyboard with an inverted-F antenna is merely illustrative, and in general the keyboard may have any desired structure.

When wireless power receiving device 24 is a trackpad, a touch sensor may be formed on or adjacent to conductive upper surface 152 of device 24. Conductive upper surface 152 may itself be a touch-sensitive surface. Edge surface 160 may define the front of the trackpad whereas edge surface 156 may define the back of the trackpad. The inverted-F antenna resonating element 108 may be formed on the back edge surface (156) of the housing. The edge surface 156 (with resonating element arm 108) of the trackpad may be closer to the desktop computer (12) during use than edge surface 160. This arrangement for a trackpad with an inverted-F antenna is merely illustrative, and in general the trackpad may have any desired structure.

The arrangement of FIG. 14 where surfaces 152, 154, 156, 158, 160, and 162 are planar is merely illustrative. In general, each surface may have one or more planar regions, curved regions, bent regions, etc. Additionally, the example of FIG. 14 where surfaces 152, 154, 156, 158, 160, and 162 define a housing for wireless power receiving device 24 is merely illustrative. Surfaces 152, 154, 156, 158, 160, and 162 may be any desired surfaces within wireless power receiving device 24. Surfaces 152, 154, 156, 158, 160, and 162 may have any desired shapes and dimensions.

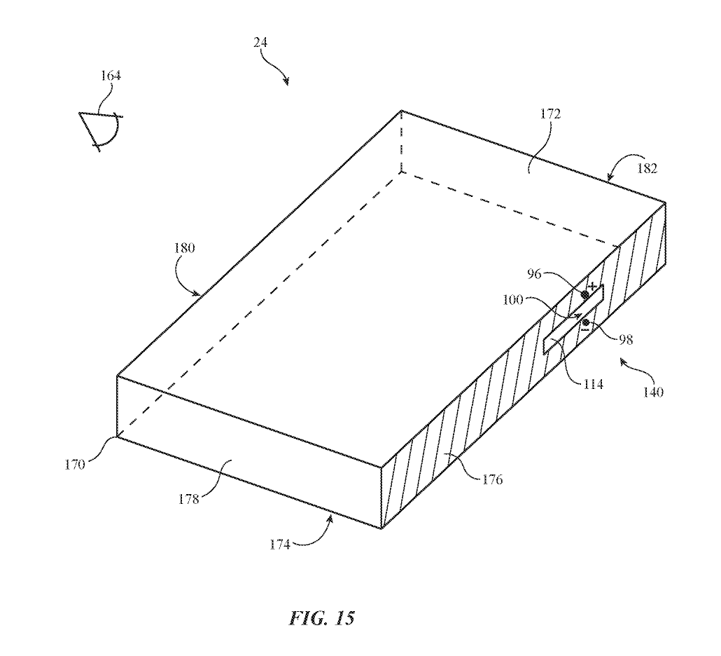

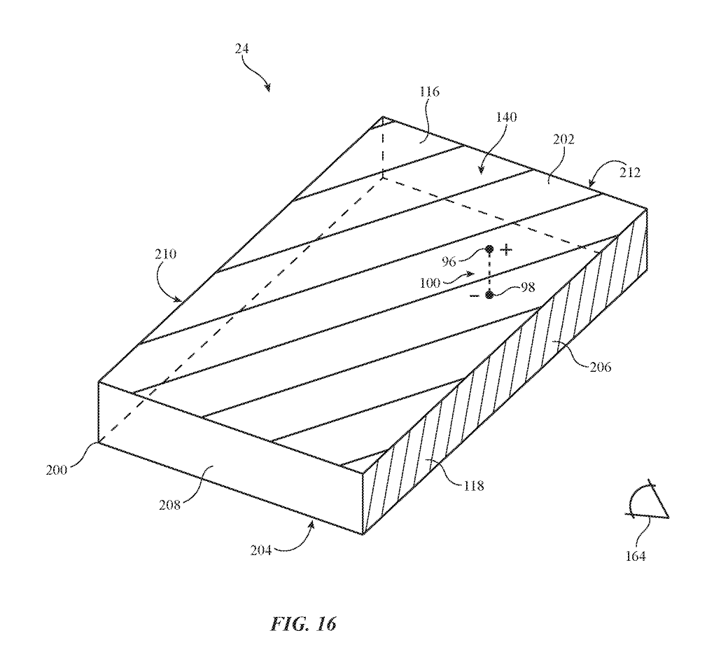

FIG. 15 is a diagram of an illustrative wireless power receiving device with a slot antenna. As shown in FIG. 15, antenna 140 in wireless power receiving device 24 may include a slot 114. Antenna 140 may have a feed 100 including a positive antenna feed terminal 96 coupled to a first side of the slot and a ground antenna feed terminal 98 coupled to a second side of the slot.

The wireless power receiving device in FIG. 15 has a housing 170 with an upper surface 172 and lower surface 174 that are connected by edge surfaces 176, 178, 180, and 182 (e.g., sidewalls). Edge surfaces 176, 178, 180, and 182 may be substantially parallel (e.g., within)15° if desired. Upper surface 172 and lower surface 174 may be dielectric or conductive. Similarly, edge surfaces 178, 180, and 182 may be dielectric or conductive. Edge surface 176 may be conductive and slot 114 may be formed in conductive edge surface 176. Ground feed terminal 98 and positive feed terminal 96 may be coupled to conductive edge surface 176. Conductive edge surface 176 may therefore serve as at least a portion of antenna ground 104 (FIG. 8). If desired, any of surfaces 172, 174, 178, 180, and 182 may be conductive. When conductive, surfaces 172, 174, 178, 180, and/or 182 may form a cavity for antenna 140 to improve the coupling efficiency of wireless power receiving device 24 to power transmitting device 12.

Any desired components may be included in housing 170. In various embodiments, wireless power receiving device 24 in FIG. 15 may be a keyboard or a trackpad. When wireless power receiving device 24 is a keyboard, keys (e.g., keys 82 in FIG. 3) may be formed on or adjacent to conductive upper surface 172 of device 24. Upper surface 172 may have openings to accommodate the keys if desired. The keys of the keyboard (24) may be configured to be viewed by a user 164 on a first side (e.g., front side) of the keyboard. In other words, edge surface 180 may define the front of the keyboard whereas edge surface 176 may define the back of the keyboard. Each key of the keyboard may have a respective glyph that is orientated to face the front (e.g., edge 180) of the keyboard. The slot element 114 may be formed on the back edge surface (156) of the housing. The edge surface 156 (with slot 114) of the keyboard may be closer to desktop computer (12) during use than edge surface 160. This arrangement for a keyboard with a slot antenna is merely illustrative, and in general the keyboard may have any desired structure.

When wireless power receiving device 24 is a trackpad, a touch sensor may be formed on or adjacent to conductive upper surface 172 of device 24. Conductive upper surface 172 may itself be a touch-sensitive surface. Edge surface 180 may define the front of the trackpad whereas edge surface 176 may define the back of the trackpad. Slot 114 may be formed on the back edge surface (156) of the housing. The edge surface 176 (with slot 114) of the trackpad may be closer to the desktop computer (12) during use than edge surface 180. This arrangement for a trackpad with a slot antenna is merely illustrative, and in general the trackpad may have any desired structure.

The arrangement of FIG. 15 where surfaces 172, 174, 176, 178, 180, and 182 are planar is merely illustrative. In general, each surface may have one or more planar regions, curved regions, bent regions, etc. Additionally, the example of FIG. 15 where surfaces 172, 174, 176, 178, 180, and 182 define a housing for wireless power receiving device 24 is merely illustrative. Surfaces 172, 174, 176, 178, 180, and 182 may be any desired surfaces within wireless power receiving device 24. Surfaces 172, 174, 176, 178, 180, and 182 may have any desired shapes and dimensions.

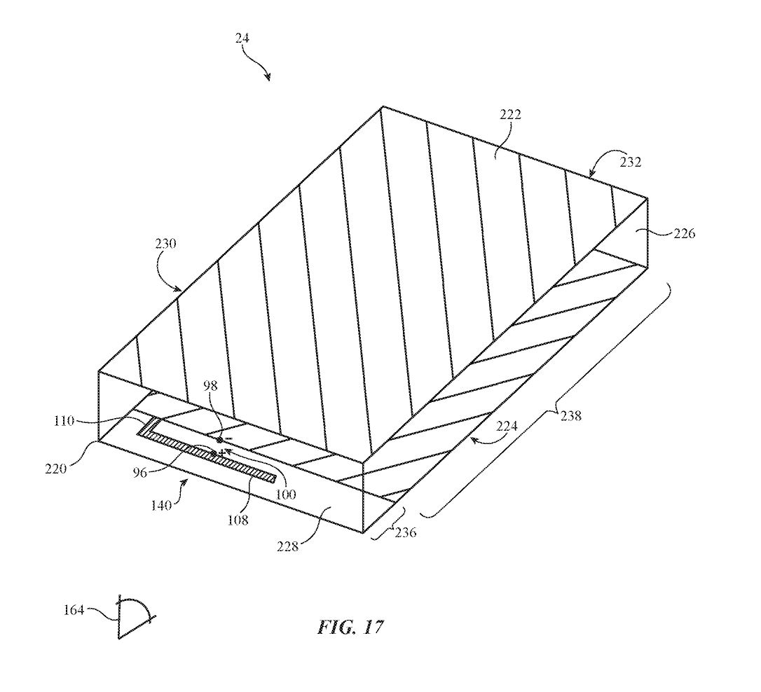

FIG. 16 is a diagram of an illustrative wireless power receiving device with a patch antenna. As shown in FIG. 16, antenna 140 in wireless power receiving device 24 may include a patch antenna resonating element such as patch antenna resonating element 116. Patch antenna resonating element 116 may be coupled to ground by arm 118 (e.g., thereby forming a planar inverted-F antenna). Antenna 140 may have a feed 100 including a positive antenna feed terminal 96 coupled to patch antenna resonating element 116 and a ground antenna feed terminal 98 coupled to a conductive layer of wireless power receiving device 24. The feed location may be selected to optimize coupling efficiency between wireless power receiving device 24 and a corresponding wireless power transmitting device (e.g., as opposed to being selected to optimize radiation efficiency).

The wireless power receiving device in FIG. 16 has a housing 200 with an upper surface 202 and lower surface 204 that are connected by edge surfaces 206, 208, 210, and 212 (e.g., sidewalls). Edge surfaces 206, 208, 210, and 212 may be substantially parallel (e.g., within) 15°) if desired. Upper surface 202 and lower surface 204 may be conductive. Edge surfaces 208, 210, and 212 may be dielectric. Edge surface 206 may be conductive. Patch antenna resonating element 116 may be formed by upper surface 202, whereas arm 118 may be formed by edge surface 206. Ground terminal 98 may be coupled to conductive lower surface 204. Conductive lower surface 204 may therefore serve as at least a portion of antenna ground 104 (FIG. 9). Conductive lower surface 204 and conductive upper surface 202 may form a cavity for antenna 140 to improve the coupling efficiency of wireless power receiving device 24 to power transmitting device 12. If desired, one or more of edge surfaces 208 and 212 may also be conductive. When conductive, edge surfaces 206, 208 and/or 212 may form a portion of a cavity for antenna 140 (e.g., surfaces 202, 204, 208, 206, and 212 may define a cavity for antenna 140).

Any desired components may be included in housing 200. In various embodiments, wireless power receiving device 24 in FIG. 16 may be a keyboard or a trackpad. When wireless power receiving device 24 is a keyboard, keys (e.g., keys 82 in FIG. 3) may be formed on or adjacent to conductive upper surface 202 of device 24. Upper surface 202 may have openings to accommodate the keys if desired. The keys of the keyboard (24) may be configured to be viewed by a user 164 on a first side (e.g., front side) of the keyboard. In other words, edge surface 206 may define the front of the keyboard whereas edge surface 210 may define the back of the keyboard. Each key of the keyboard may have a respective glyph that is orientated to face the front (e.g., edge 206) of the keyboard. Edge surface 206 (which forms arm 118 for the patch antenna) of the keyboard may be further from the desktop computer (12) during use than edge surface 210. This arrangement for a keyboard with a patch antenna is merely illustrative, and in general the keyboard may have any desired structure.

When wireless power receiving device 24 is a trackpad, a touch sensor may be formed on or adjacent to conductive upper surface 202 of device 24. Conductive upper surface 202 may itself be a touch-sensitive surface. Edge surface 206 may define the front of the trackpad whereas edge surface 210 may define the back of the trackpad. Arm 118 for coupling the patch antenna resonating element 116 to ground may be formed by the front edge surface (206) of the housing. The edge surface 206 (which forms arm 118 for the patch antenna) of the trackpad may be further from the desktop computer (12) during use than edge surface 210. This arrangement for a trackpad with a patch antenna is merely illustrative, and in general the trackpad may have any desired structure.

The arrangement of FIG. 16 where surfaces 202, 204, 206, 208, 210, and 212 are planar is merely illustrative. In general, each surface may have one or more planar regions, curved regions, bent regions, etc. Additionally, the example of FIG. 16 where surfaces 202, 204, 206, 208, 210, and 212 define a housing for wireless power receiving device 24 is merely illustrative. Surfaces 202, 204, 206, 208, 210, and 212 may be any desired surfaces within wireless power receiving device 24. Surfaces 202, 204, 206, 208, 210, and 212 may have any desired shapes and dimensions.

FIG. 17 is a diagram of an illustrative wireless power receiving device with an inverted-F antenna. As shown in FIG. 17, antenna 140 in wireless power receiving device 24 may include a resonating element arm such as arm 108. Antenna resonating element arm 108 may be coupled to ground by return path 110. Antenna 140 may have a feed 100 including a positive antenna feed terminal 96 coupled to antenna resonating element arm 108 and a ground antenna feed terminal 98 coupled to a conductive layer of wireless power receiving device 24.

The wireless power receiving device in FIG. 17 has a housing 220 with an upper surface 222 and lower surface 224 that are connected by edge surfaces 226, 228, 230, and 232 (e.g., sidewalls). Edge surfaces 226, 228, 230, and 232 may be substantially parallel (e.g., within 15°) if desired. Upper surface 222 may be conductive. Lower surface 224 may have a conductive portion 238 and a dielectric portion 236. Edge surfaces 226, 228, 230, and 232 may be dielectric. Antenna resonating element arm 108 and return path 110 may be formed on (or behind) dielectric portion 236 of lower surface 224. Ground terminal 98 may be coupled to conductive portion 238 of lower surface 224. Conductive portion 238 of lower surface 224 may therefore serve as at least a portion of antenna ground 104 (FIG. 7). Conductive lower surface 224 and conductive upper surface 222 may form a cavity for antenna 140 to improve the coupling efficiency of wireless power receiving device 24 to power transmitting device 12. If desired, one or more of edge surfaces 226, 228, 230, and 232 may also be conductive. When conductive, one or more of edge surfaces 226, 228, 230, and 232 may form a portion of a cavity for antenna 140 (e.g., surfaces 222, 224, 226, 228, 230, and/or 232 may define a cavity for antenna 140).

Any desired components may be included in housing 220. In one arrangement, wireless power receiving device 24 in FIG. 17 may be a computer mouse. When wireless power receiving device 24 is a mouse, a touch sensor (e.g., touch sensor 90 in FIG. 5) and/or a button (e.g., button 92 in FIG. 5) may be formed on or adjacent to conductive upper surface 222 of device 24. Conductive upper surface 222 may itself be a touch-sensitive surface. Edge surface 228 may define the front of the mouse whereas edge surface 232 may define the back of the mouse. The inverted-F antenna resonating element 108 may be formed on the front side of the housing. The edge surface 232 of the mouse may be closer to the desktop computer (12) during use than edge surface 228. This arrangement for a mouse with an inverted-F antenna is merely illustrative, and in general the mouse may have any desired structure.

The arrangement of FIG. 17 where surfaces 222, 224, 226, 228, 230, and 232 are planar is merely illustrative. In general, each surface may have one or more planar regions, curved regions, bent regions, etc. Additionally, the example of FIG. 17 where surfaces 222, 224, 226, 228, 230, and 232 define a housing for wireless power receiving device 24 is merely illustrative. Surfaces 222, 224, 226, 228, 230, and 232 may be any desired surfaces within wireless power receiving device 24. Surfaces 222, 224, 226, 228, 230, and 232 may have any desired shapes and dimensions.

In some of the arrangements herein, antennas in wireless power transmitting device 12 (e.g., FIG. 13) and antennas in wireless power receiving device 24 (e.g., FIGS. 14-17) may include a cavity. In these arrangements, portions of the cavity for the antenna may also be used to form the housing for the device, thus allowing an attractive metal form factor and high mechanical strength. The dimensions of these cavities may be tuned by adding and/or removing conductive material in certain locations to optimize coupling efficiency between a wireless power receiving device and a corresponding wireless power transmitting device (e.g., as opposed to being tuned to optimize radiation efficiency).

The foregoing is merely illustrative and various modifications can be made by those skilled in the art without departing from the scope and spirit of the described embodiments. The foregoing embodiments may be implemented individually or in any combination.

What is claimed is:

1. An electronic device that is configured to receive radio-frequency signals from external electronic equipment, the electronic device comprising:
a housing having conductive portions;
an input-output component in the housing;
a battery in the housing;
an antenna configured to receive the radio-frequency signals from the external electronic equipment, wherein the conductive portions of the housing form a cavity for the antenna; and
rectifier circuitry that is configured to convert the radio-frequency signals received by the antenna into a direct current voltage that charges the battery.

2. The electronic device defined in claim 1, wherein the housing includes a conductive upper surface, a conductive lower surface, and an edge surface that extends between the conductive upper surface and the conductive lower surface.

3. The electronic device defined in claim 2, wherein the antenna includes a conductive antenna resonating element arm on a dielectric portion of the edge surface.

4. The electronic device defined in claim 3, wherein the antenna includes an antenna feed having a first feed terminal coupled to the conductive antenna resonating element arm, a second feed terminal coupled to the conductive lower surface of the housing, and a return path coupled between the conductive antenna resonating element arm and the conductive lower surface of the housing.

5. The electronic device defined in claim 4, wherein the edge surface is a first edge surface, the housing has a rectangular periphery, the first edge surface, a second edge surface, a third edge surface, and a fourth edge surface run around the rectangular periphery of the housing, and the second edge surface, the third edge surface, and the fourth edge surface are conductive and form a portion of the cavity for the antenna.

6. The electronic device defined in claim 5, wherein the input-output component comprises a plurality of keys that each have a respective glyph oriented to face away from the first edge surface.

7. The electronic device defined in claim 2, wherein the edge surface is conductive and the antenna includes a slot in the conductive edge surface.

8. The electronic device defined in claim 7, wherein the antenna includes an antenna feed having a first feed terminal coupled to a first side of the slot and a second feed terminal coupled to an opposing second side of the slot.

9. The electronic device defined in claim 8, wherein the edge surface is a first edge surface, the housing has a rectangular periphery, the first edge surface, a second edge surface, a third edge surface, and a fourth edge surface run around the rectangular periphery of the housing, and the second edge surface, the third edge surface, and the fourth edge surface are conductive and form a portion of the cavity for the antenna.

10. The electronic device defined in claim 9, wherein the input-output component comprises a plurality of keys that each have a respective glyph oriented to face away from the first edge surface.

11. The electronic device defined in claim 2, wherein the antenna includes an antenna feed having a first feed terminal coupled to the conductive upper surface and a second feed terminal coupled to the conductive lower surface and the edge surface is a conductive edge surface.

12. The electronic device defined in claim 11, wherein the input-output component comprises a plurality of keys that each have a respective glyph oriented to face towards the first edge surface.

13. The electronic device defined in claim 1, wherein an upper surface of the housing is touch-sensitive.

14. The electronic device defined in claim 1, wherein the housing includes a lower surface with a conductive portion and a dielectric portion, the antenna includes a conductive antenna resonating element arm on the dielectric portion of the lower surface of the housing, and the antenna includes an antenna feed having a first feed terminal coupled to the conductive antenna resonating element arm, a second feed terminal coupled to the conductive portion of the lower surface of the housing, and a return path coupled between the conductive antenna resonating element arm and the conductive portion of the lower surface of the housing.

15. The electronic device defined in claim 1, wherein the radio-frequency signals received by the antenna comprise radio-frequency signals at a frequency between 500 MHz and 6000 MHz.

16. An electronic device having a front face and a rear face and that is configured to transmit wireless charging signals that charge an accessory device, the electronic device comprising:
a housing having a conductive portion;
a display in the housing that forms at least a portion of the front face of the electronic device;
a conductive reflector that forms at least a portion of the rear face of the electronic device; and
an antenna at the front face of the electronic device that is configured to transmit the wireless charging signals, wherein the conductive portion of the housing and the reflector form a cavity for the antenna.

17. The electronic device defined in claim 16, wherein the conductive portion of the housing has a curved portion and wherein the antenna is positioned on the curved portion.

18. The electronic device defined in claim 16, wherein the display has a transparent cover layer that is supported by an upper edge of the conductive portion of the housing.

19. The electronic device defined in claim 16, wherein the wireless charging signals transmitted by the antenna comprise wireless charging signals at a frequency between 500 MHz and 6000 MHz.

20. A keyboard having opposing first and second sides that is configured to receive radio-frequency signals from external electronic equipment, the keyboard comprising:
a plurality of keys that are configured to be pressed;
a plurality of glyphs that are orientated to face the first side of the keyboard, wherein each key of the plurality of keys has an associated glyph of the plurality of glyphs;
a battery;
an antenna at the second side of the keyboard that is configured to receive the radio-frequency signals from the external electronic equipment, wherein the radio-frequency signals received by the antenna comprise radio-frequency signals at a frequency between 500 MHz and 6000 MHz;
rectifier circuitry that is configured to convert the radio-frequency signals received by the antenna into a direct current voltage; and
circuitry that is configured to charge the battery using the direct current voltage.
